(19) United States
(12) Patent Application Publication
(10) Pub. No.: US 2017/0372347 A1
(43) Pub. Date: Dec. 28, 2017

(54) SEQUENCE-BASED MARKETING ATTRIBUTION MODEL FOR CUSTOMER JOURNEYS

(71) Applicant: INTERNATIONAL BUSINESS MACHINES CORPORATION, Armonk, NY (US)

(72) Inventors: Ying Li, Mohegan Lake, NY (US); Pietro Mazzoleni, New York, NY (US); Pavankumar Murali, Elmsford, NY (US); Roman Vaculin, Bronxville, NY (US); Zi Yin, Stanford, CA (US)

(21) Appl. No.: 15/189,648

(22) Filed: Jun. 22, 2016

(51) Int. Cl. G06Q 30/02; G06Q 10/06

(52) U.S. Cl. CPC G06Q 30/0242; G06Q 10/067

(57) ABSTRACT

Methods and a system are provided. A method includes extracting subsequences from a sequence of a customer journey that includes customer interactions on different channels at different times on different topics. The method further includes measuring an effectiveness of each of the subsequences based on journey success data, by applying a statistical hypothesis testing approach. The method also includes determining a contribution of each of the customer interactions for a given one of the subsequences, by applying a sequence-based journey attribution model.

### BACKGROUND

### Technical Field

The present invention relates generally to information processing and, in particular, to a sequence-based marketing attribution model for customer journeys.

### Description of the Related Art

Marketing attribution is the process of quantifying how a set of user marketing touches and responses (e.g. email, chat, visit a site) contributed to a desired outcome, typically revenue or customer satisfaction. A customer journey can be considered as the complete sum of touches and responses that customers go through when interacting with an organization, from initial contact, through purchasing, after sales support, and hopefully onto repurchase and advocacy. The goal of a customer journey is to understand how customers behave across multiple interactions regardless of channel so that an organization can deliver a consistent exceptional experience. However, as channels and types of interactions increase, resulting in an explosion in the number of different journeys a customer can take, there is a need to determine what is the “typical” or “best” (in terms as more effective) customer journey under such circumstances.

### SUMMARY

According to an aspect of the present principles, a method is provided. The method includes extracting subsequences from a sequence of a customer journey that includes customer interactions on different channels at different times on different topics. The method further includes measuring an effectiveness of each of the subsequences based on journey success data, by applying a statistical hypothesis testing approach. The method also includes determining a contribution of each of the customer interactions for a given one of the subsequences, by applying a sequence-based journey attribution model.

According to another aspect of the present principles, a computer program product is provided for analyzing a sequence of a customer journey. The computer program product includes a non-transitory computer readable storage medium having program instructions embodied therewith. The program instructions are executable by a computer to cause the computer to perform a method. The method includes extracting subsequences from the sequence of the customer journey. The method further includes measuring an effectiveness of each of the subsequences based on journey success data, by applying a statistical hypothesis testing approach. The method also includes determining a contribution of each of the customer interactions for a given one of the subsequences, by applying a sequence-based journey attribution model. The customer journey includes customer interactions on different channels at different times.

According to yet another aspect of the present principles, a system is provided. The system includes a hardware processor, configured to extract subsequences from a sequence of a customer journey that includes customer interactions on different channels at different times. The hardware processor is further configured to measure an effectiveness of each of the subsequences based on journey success data, by applying a statistical hypothesis testing approach. The hardware processor is also configured to determine a contribution of each of the customer interactions for a given one of the subsequences, by applying a sequence-based journey attribution model.

According to still another aspect of the present principles, a method is provided. The method includes extracting subsequences from a sequence of a customer journey that includes customer interactions on different channels at different times. The method further includes measuring an effectiveness of each of the subsequences by applying a statistical hypothesis approach that computes a likelihood ratio test for each of the subsequences based on effective journey history. The method also includes determining a contribution of each of the customer interactions for a given one of the subsequences by computing an attribution of the customer interactions using a sequence-based journey attribution model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with an embodiment of the present principles;

FIG. 2 shows an exemplary system architecture for sequences-based marketing attribution model for customer journeys, in accordance with an embodiment of the present principles;

FIG. 3 shows an exemplary method for employing a sequences-based marketing attribution model for customer journeys, in accordance with an embodiment of the present principles;

FIG. 4 shows an exemplary method for determining an effective measurement for a journey subsequence, in accordance with an embodiment of the present principles;

FIG. 5 shows an exemplary cloud computing environment, in accordance with an embodiment of the present principles; and

FIG. 6 shows an exemplary set of functional abstraction layers provided by the cloud computing environment shown in FIG. 5, in accordance with an embodiment of the present principles.

### DETAILED DESCRIPTION OF PREFERRED EMBODIMENTS

The present principles are directed to a sequence-based marketing attribution model for customer journeys.

In an embodiment, the present principles advantageously provide a new definition of an effective subsequence, provide a generic statistical framework to measure the effectiveness of a temporal sequence of interactions, and provide a sequence-based attribution model to measure the contribution of an interaction in the context of a given sequence. As used herein, a “customer interaction” or “interaction” in short is an interaction between a customer (or prospect) and a company.

In an embodiment, the present principles use sequencing techniques to mine the effectiveness of journey sub-sequences by analyzing a large number of successful and unsuccessful journeys. In an embodiment, the sub-sequencing analysis aids marketers to synthesize the root cause (in this case sub-sequences mined from large number of noisy journey data) associated to a behavior. In an embodiment, the present principles further analyze the contribution of each sequence state, called attribution, to the success of each sequence. It is to be appreciated that a sequence state can involve more than one interaction.

In an embodiment, an innovative algorithm is provided which inputs the following two sets of data: “success” and “failures” journeys and “marketing goals”. In an embodiment, the present principles use a sequence mining algorithm to quantify each touch/response in the context of such goals.

The concept relates to digital marketing that involves a statistical analysis of a user's experience (e.g., a customer) with an organization through the user's journey (initial contact to final dealing, e.g., browsing, purchase, after sales support, etc.).

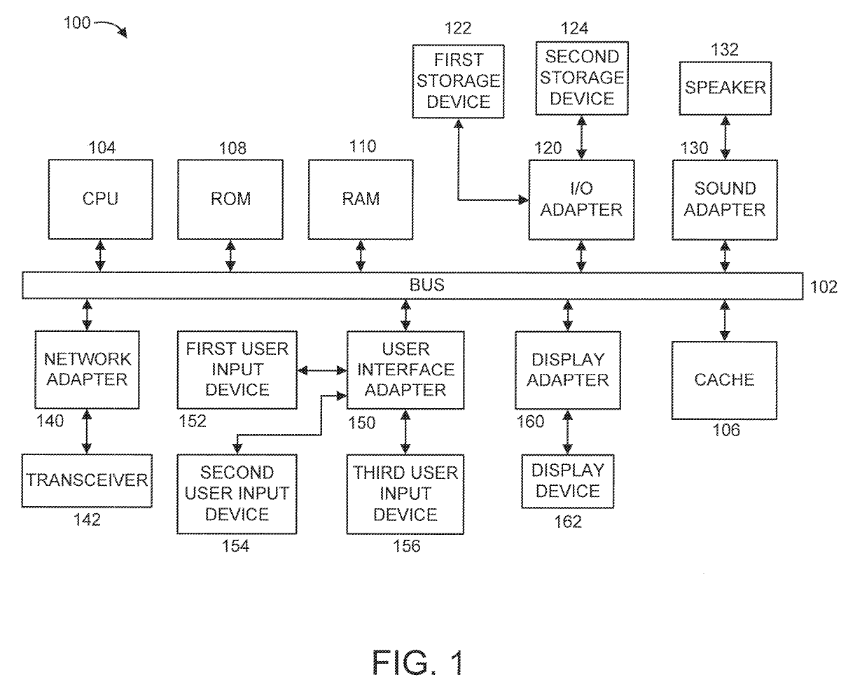

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

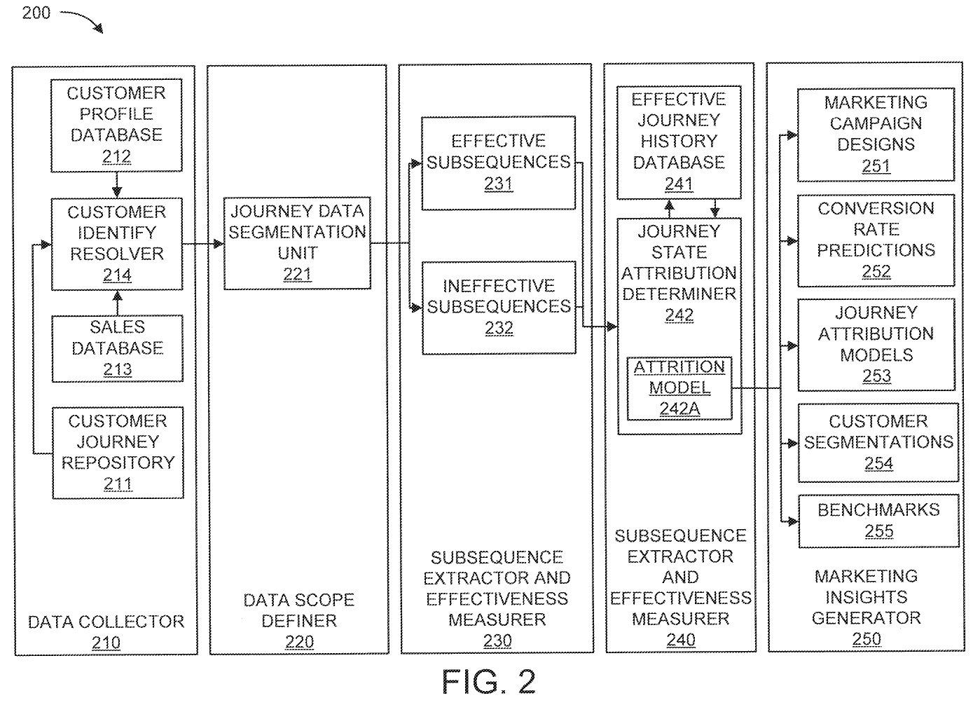

Moreover, it is to be appreciated that system 200 described below with respect to FIG. 2 is a system for implementing respective embodiments of the present principles. Part or all of processing system 100 may be implemented in one or more of the elements of system 200.

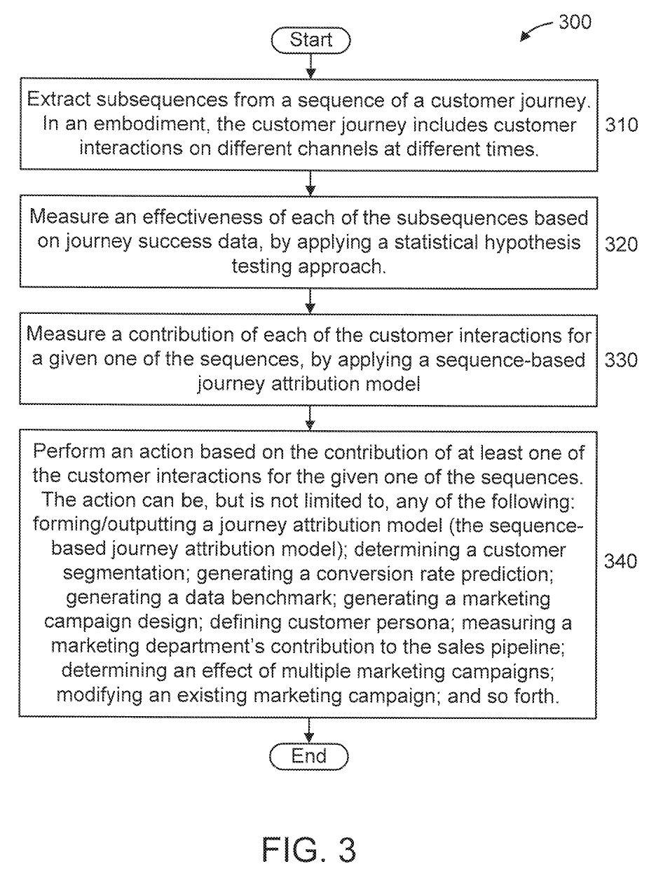

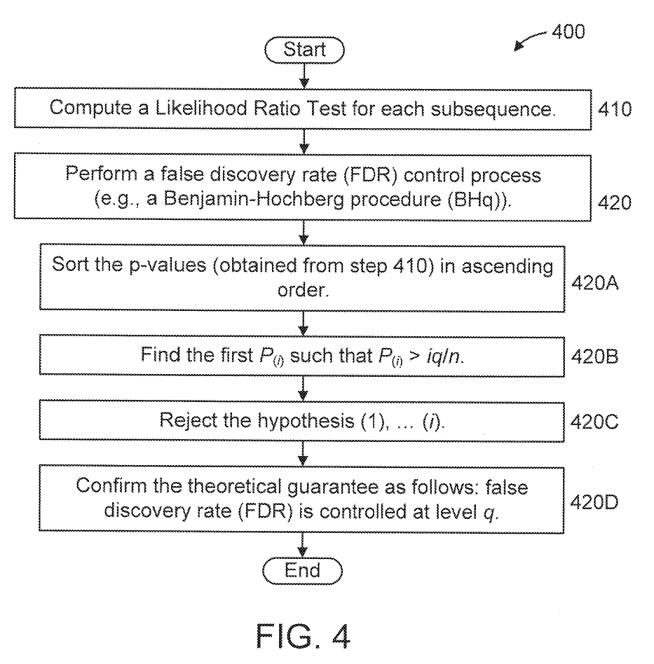

Further, it is to be appreciated that processing system 100 may perform at least part of the method described herein including, for example, at least part of method 300 of FIG. 3 and/or at least part of method 400 of FIG. 4. Similarly, part or all of system 200 may be used to perform at least part of method 300 of FIG. 3 and/or at least part of method 400 of FIG. 4.

FIG. 2 shows an exemplary system architecture 200 for sequences-based marketing attribution model for customer journeys, in accordance with an embodiment of the present principles.

The system architecture 200 includes a data collector 210, a data scope definer portion 220, a subsequence extractor and effectiveness measurer 230, a sequence state attribution measurer 240, and a marketer insights generator 250.

The data collector 210 includes a customer journey repository 211, a customer profile database 212, a sales database 213, and a customer identify resolver 214.

The customer identify resolver 214 receives inputs from the customer journey database 211, the customer profile database 212, and the sales database 213. The customer identity resolver 214 matches customer profile and sales data in case an ambiguous representations exists. For example, the customer identity resolver 214 can match user profile data collected from public social media to sales data. Of course, other data can be matched by the customer identity resolver 214.

The data scope definer 220 defines the data that will be used for analysis. The data scope definer 220 includes a journey data segmentation unit 221 for segmenting the journey data. At a macro level, all available data can be used for analysis. At a micro level, a user could decide to restrict the analysis only to a limited amount of data. As an example of micro-level, analyze the data that correspond to a particular industry. As another example, of micro-level, analyze the data that correspond to a particular customer segment based on, for example, age.

The subsequence extractor and effectiveness measurer 230 extracts subsequences from an input sequence, and determines/measures whether the subsequences are effective subsequences 231 or ineffective subsequences 232 based on effectiveness criteria.

The sequence state attribution measurer 240 determines/measures a sequence state attribution. The sequence state attribution measurer 240 includes an effective journey history database 241 and a journey state attribution determiner 242 that includes an attribution model 242A.

The marketer insights generator 250 generates marketer insights that can include, but are not limited to, marketing campaign designs 251, conversion rate predictions 252, journey attribution models 253, customer segmentations 254, and benchmarks 255.

In the embodiment shown in FIG. 2, at least one of the elements is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. Moreover, one or more elements of FIG. 2 can be implemented in a cloud configuration including, for example, in a distributed configuration. Accordingly, the elements of FIG. 2 may be located at disparate locations, but nonetheless act cooperatively in accordance with the teachings of the present principles. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of system architecture 200 are readily determined by one of ordinary skill in the art, given the teachings of the present principles provided herein, while maintaining the spirit of the present principles.

The following terms will now be defined, in accordance with an embodiment of the present principles.

A “customer interaction” is an interaction between a customer (or prospect) and a company. Interactions are either initiated by the customer (e.g. visit a site or call to a call-center) or by the marketer (e.g. send email, sales-rep visit). Each interaction can be identified by, for example, a channel, a date, and an area (e.g. IBM Cloud email Campaign, Technical Support call-center). In addition, an interaction can include additional (structured or unstructured) information (e.g. transcript of a call, sequences and time spent on pages) which could be used to further identify the type of interaction.

An “interaction” is interchangeably referred to herein as action or state or event in the context of a sequence or journey.

A “customer journey” is a sequence of interactions associated to a specific individual or decision making unit (e.g. members of the same family, employee of the same company).

A “subsequence journey” is a sub-sequence of interactions within a journey.

“Journey success/failure metrics” is a set of metrics which indicates the success level of a journey. Examples of success metrics can include, but are not limited to, for example, “purchase a product”, “becoming an advocate for the brand”, and so forth. Examples of failure metrics can include, but are not limited to, for example, “abandon cart”, “left feedback on site”, “become a detractor for the brand”, and so forth.

A “successful journey” is a journey that ends with a success metric. An “unsuccessful journey” is a journey that ends with a failure metric. It is to be appreciated that there can be journeys which are neither successful nor unsuccessful, but instead are in a pending state waiting for a new interaction to happen.

A description will now be given regarding subsequences, in accordance with an embodiment of the present principles.

A subsequence plays a key role in our analysis. An example of subsequence from IBM dataset:

Original sequence:

Nurture email, IBM Analytics→Event Invitation, Marketing→Event Invitation, IBM Analytics→Event Invitation, IBM Systems→Unsolicited email, IBM Systems→Event Invitation, IBM Analytics

A subsequence:

Event Invitation, Marketing→Unsolicited email, IBM Systems→Event Invitation, IBM Analytics

An “effective journey subsequence” s is effective if the sequences that include subsequence s have a higher rate of success.

The preceding definition used the following assumptions. Suppose a subsequence s is effective. Then any sequence including it will have success probability p. Also, sequences that does not include any effective subsequences (ESS) will have success probability q<p. Thus, the problem can be approached using statistical testing.

FIG. 3 shows an exemplary method 300 for employing a sequences-based marketing attribution model for customer journeys, in accordance with an embodiment of the present principles.

At step 310, extract subsequences from a sequence of a customer journey. In an embodiment, the customer journey includes customer interactions on different channels at different times. In an embodiment, step 310 can be performed based on a data scope definition that defines the data that will be used for analysis.

At step 320, measure an effectiveness of each of the subsequences based on journey success data, by applying a statistical hypothesis testing approach. An embodiment of step 320 is shown and described with respect to FIG. 4.

At step 330, measure a contribution of each of the customer interactions for a given one of the sequences, by applying a sequence-based journey attribution model. In an embodiment, step 330 can involve calculating coefficients for the sequence-based journey attribution model.

At step 340, perform an action based on the contribution of at least one of the customer interactions for the given one of the sequences. The action can be, but is not limited to, any of the following: forming/outputting a journey attribution model (the sequence-based journey attribution model); determining a customer segmentation; generating a conversion rate prediction; generating a data benchmark; generating a marketing campaign design; defining customer persona; measuring a marketing department's contribution to the sales pipeline; determining an effect of multiple marketing campaigns; modifying an existing marketing campaign; and so forth.

In an embodiment, a multi-campaign attribution methodology measures the effect of a first touch (a campaign that first brought in an account), a last touch (a campaign that was presented immediately prior to the closing of a deal or creation of a sales-ready opportunity), and any significant re-touch events (campaigns that represent lead-nurturing and/or remarketing efforts). The significant re-touch events can be determined based on the contribution determined for an event (as per step 340), with respect to a threshold contribution amount.

FIG. 4 shows an exemplary method 400 for determining an effective measurement for a journey subsequence, in accordance with an embodiment of the present principles.

At step 410, compute a Likelihood Ratio Test for each subsequence. The output of the Likelihood Ratio Test is a sequence of p-values. Each of the p-values represents a probability of attributing the outcome to a certain subsequence in test.

For example, compute the following:

$$\begin{matrix} & + ve & - ve & \\ ∈ & {x}_{11} & {x}_{12} & {n}_{1} \\ ∉ & {x}_{21} & {x}_{22} & {n}_{2}\end{matrix}$$

$$where$$

$${n}_{1} = {x}_{11} + {x}_{12}$$

$$and$$

$${n}_{2} = {x}_{21} + {x}_{22} \cdot 2 log = 2 ( {x}_{11} log \frac{{x}_{11}}{{n}_{1}} + {x}_{12} log \frac{{x}_{12}}{{n}_{1}} + {x}_{21} log \frac{{x}_{21}}{{n}_{2}} + {x}_{22 } log \frac{{x}_{22}}{{n}_{2}} ) - 2 ( ( {x}_{11} + {x}_{21} ) log \frac{{x}_{11} + {x}_{21}}{{n}_{1} + {n}_{2}} + ( {x}_{12} + {x}_{22} ) log \frac{{x}_{12} + {x}_{22}}{{n}_{1} + {n}_{2}} )$$

follows χ²(1) distribution under H₀ when n₁, n₂ are large.

The following definitions apply:
H₀: hypothesis 0.
+ve: successful journeys that include the subsequence s in test.
−ve: unsuccessful journeys that include the subsequence s in test.
x₁₁: the number of subsequences, which include s and have contributed to successful journeys.
x₁₂: the number of subsequences, which include s and have led to unsuccessful journeys.

At step 420, perform a false discovery rate (FDR) control process. In an embodiment, a Benjamin-Hochberg procedure (BHq) is performed to control the false discovery rate. The FDR can be generally defined as the ratio of the number of erroneously rejected hypothesis among all rejected hypothesis.

In an embodiment, step 420 includes steps 420A-D.

At step 420A, sort the p-values (obtained from step 410) in ascending order.

At step 420B, find the first P₍ᵢ₎ such that

$${P}_{( i )} \geq \frac{iq}{n} ,$$

where P(ᵢ) denote a first p-value, i denotes the rank order in the sorted list of p-values, q denotes a nominal value such that 0<q<1, and n denotes the number of null hypotheses.

At step 420C, reject the hypothesis (1), . . . , (i).

At step 420D, confirm the theoretical guarantee as follows: false discovery rate (FDR) is controlled at level q.

Other metrics for measuring effectiveness include, but are not limited to, the following: (i) user response rate to each campaign touch (or interaction); (ii) indicator of who initiates each campaign interaction (more encouraging if user takes the initiative); and (iii) client segment. Of course, the preceding metrics are merely illustrative and, thus, other metrics can also be used to measure effectiveness while maintaining the spirit of the present principles.

A description will now be given regarding sequence-based interaction attribution, in accordance with an embodiment of the present principles.

The present principles provide a sequence-based attribution model to measure the contribution of an interaction in the context of a given sequence.

Consider the following two temporal sequences:
nurture email, IBM analytics→email, IBM analytics→event invitation, IBM analytics (Positive sequence)
event invitation, IBM analytics→direct mail, IBM analytics→nurture email, IBM analytics (Negative sequence)

The same action would contribute differently in the context of two different sequences.

For an interaction a in a sequence s, compute its attribution by the following:

Attrib(a|s)=success rate of s−success rate of s/a.

The underlying principle is as follows:

If Attrib(a|s)>0: the interaction a is contributing to the overall campaign positively.

If Attrib(a|s)<=0: the interaction a is negatively contributing, or at least, shows no positive effect.

The challenge is how to estimate the success rate of a sequence.

In accordance with the present principles, the success rate of sequence s is measured as the success rate of the ESS (effective subsequence) that s includes. In an embodiment, the success rate of an ESS is measured as the ratio between the total number of successful (positive) sequences and the total number of sequences, which have included this ESS.

A brief description will now be given regarding exemplary applications to which the present principles may be applied, in accordance with an embodiment of the present principles.

Such applications include, but are not limited to, a journey attribution model, customer Segmentation, conversion rate prediction, data Benchmark, and campaign design.

A brief description will now be given regarding applications that involve a journey attribution model in accordance with the present principles.

Attribution models determine credit to marketing a touch/response with respect to the achievement of a given company goal(s). As an example, a “last interaction touch” attributes a given customer sales to the most recent marketing interaction the company had with that customer. On the other hand, a “linear” marketing attribution model uniformly distributes the credit to all marketing interactions the customer had with the brand. Examples of some popular attribution models include, but are not limited to, “last interaction”, “time decay”, “position based”, “linear”, “first interaction”, and “last non-direct click”.

In an embodiment, a new attribution model is provided which not only considers positive credit to touches/responses, but also assigns negative credit based on the computed successful/unsuccessful journeys. In addition, it will consider sequences of interaction instead of single touch/responses.

A brief description will now be given regarding applications that involve a customer persona definition.

Customer Persona are a generalized representation of ideal customers. Persona are used by marketers to identify (and internalize) customer needs and better serve the customers with campaigns and products.

Traditionally, customer persona are defined using customer surveys. In an embodiment of the present principles, marketers are advised in discovering and tracking persona behavior based on common effective and ineffective sequences.

In an embodiment, a marker feeds the system of the present principles with journey data of individuals being recognized from the same persona. The system will then identify if the individuals are reporting a similar behavior and/or where are the most and least effective sub-sequences from the journey data

In another embodiment, existing clustering algorithms can be applied to the output(s) of the present principles to intelligently discover new persona based on common effective/ineffective sequences interactions.

A brief description will now be given regarding applications that involve a conversation rate prediction, in accordance with an embodiment of the present principles.

In the embodiment, the conversion rate of a single customer is predicted by mapping the single customer's current journey to historical effective sequences.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

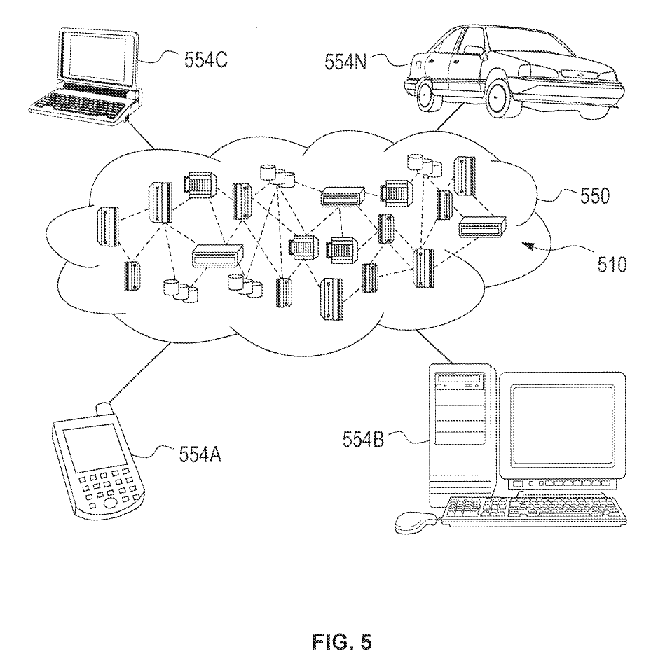

Referring now to FIG. 5, illustrative cloud computing environment 550 is depicted. As shown, cloud computing environment 550 includes one or more cloud computing nodes 510 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 510 and cloud computing environment 550 can communicate with any type of computerized device over any type of network and/or network addressable connection (e.g., using a web browser).

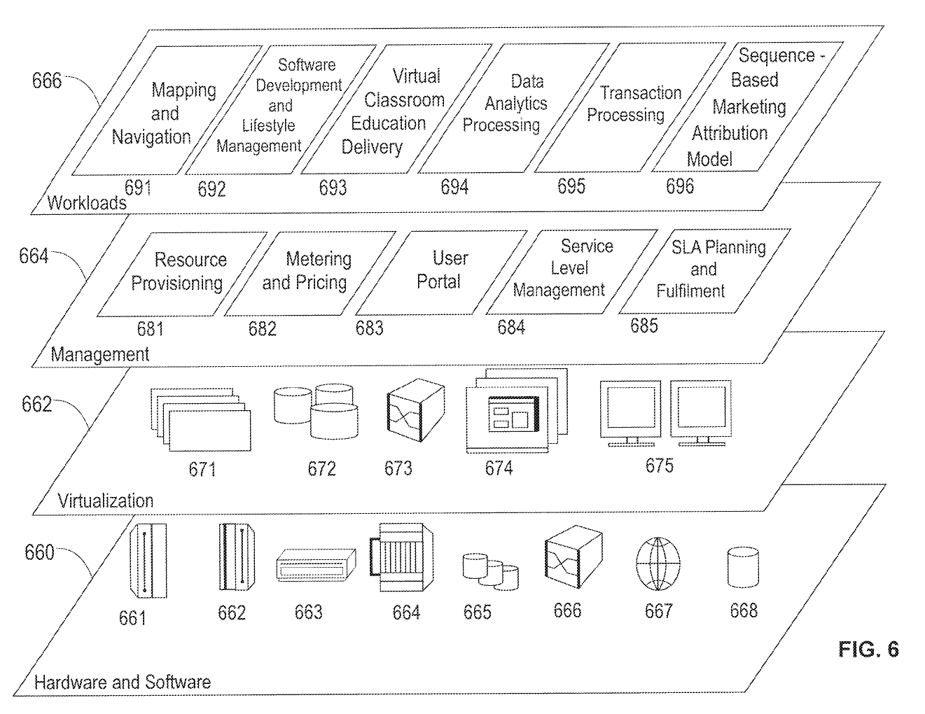

Referring now to FIG. 6, a set of functional abstraction layers provided by cloud computing environment 550 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and sequence-based marketing attribution model for customer journeys 696.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
extracting subsequences from a sequence of a customer journey that includes customer interactions on different channels at different times on different topics;
measuring an effectiveness of each of the subsequences based on journey success data, by applying a statistical hypothesis testing approach; and
determining a contribution of each of the customer interactions for a given one of the subsequences, by applying a sequence-based journey attribution model.

2. The method of claim 1, wherein the statistical hypothesis testing approach comprises computing a likelihood ratio test for each of the subsequences.

3. The method of claim 2, wherein computing the likelihood ratio test for a given subsequence from among the subsequences comprises determining successful journeys that include the given subsequence and unsuccessful journeys that include the given subsequence.

4. The method of claim 2, wherein the likelihood ratio test is a logarithm-likelihood ratio test.

5. The method of claim 1, wherein the journey success data comprises (i) a number of the subsequences that include the given subsequence and have contributed to a successful journey, and (ii) a number of the subsequences that include the given subsequence and have led to an unsuccessful journey.

6. The method of claim 1, wherein said measuring step comprises performing a false discovery rate control process.

7. The method of claim 1, wherein said determining step comprises determining an attribution of a given customer interaction in a given subsequence using the sequence-based journey attribution model, from among the customer interactions in the subsequences.

8. The method of claim 7, wherein the attribution of the given customer interaction is determined as a difference between a first success rate and a second success rate, the first success rate being a success rate of the given subsequence without an occurrence of the given customer interaction, and the second success rate being a success rate of the given subsequence with the occurrence of the given customer interaction.

9. The method of claim 1, wherein said determining step comprises determining a success rate of a given subsequence from among the subsequences as a ratio between (i) a total number of successful subsequences that include the given subsequence and (ii) a total number of sequences that include the given subsequence.

10. The method of claim 1, further comprising measuring a marketing contribution to a sales pipeline using the sequence-based journey attribution model, the marketing contribution being measured across multiple marketing campaigns.

11. The method of claim 10, wherein the marketing contribution comprises a first customer interaction, a last customer interaction, and any significant customer interactions determined based on the contributions thereof being above a threshold amount.

12. The method of claim 1, modifying, using the sequence-based journey attribution model, an existing marketing campaign provided over one or more networks, wherein said modifying step comprises altering marketing content displayed on display devices to users over the one or more networks.

13. A computer program product for analyzing a sequence of a customer journey, the computer program product comprising a non-transitory computer readable storage medium having program instructions embodied therewith, the program instructions executable by a computer to cause the computer to perform a method comprising:
extracting subsequences from the sequence of the customer journey;
measuring an effectiveness of each of the subsequences based on journey success data, by applying a statistical hypothesis testing approach; and
determining a contribution of each of the customer interactions for a given one of the subsequences, by applying a sequence-based journey attribution model,
wherein the customer journey includes customer interactions on different channels at different times.

14. The method of claim 13, wherein the statistical hypothesis testing approach comprises computing a likelihood ratio test for each of the subsequences.

15. The method of claim 14, wherein computing the likelihood ratio test for a given subsequence from among the subsequences comprises determining successful journeys that include the given subsequence and unsuccessful journeys that include the given subsequence.

16. The method of claim 13, wherein said determining step comprises determining a success rate of a given subsequence from among the subsequences as a ratio between (i) a total number of successful subsequences that include the given subsequence and (ii) a total number of sequences that include the given subsequence.

17. A system, comprising:
a hardware processor, configured to:
extract subsequences from a sequence of a customer journey that includes customer interactions on different channels at different times;
measure an effectiveness of each of the subsequences based on journey success data, by applying a statistical hypothesis testing approach; and
determine a contribution of each of the customer interactions for a given one of the subsequences, by applying a sequence-based journey attribution model.

18. The system of claim 17, wherein the statistical hypothesis testing approach comprises computing a likelihood ratio test for each of the subsequences.

19. The system of claim 18, wherein computing the likelihood ratio test for a given subsequence from among the subsequences comprises determining successful journeys that include the given subsequence and unsuccessful journeys that include the given subsequence.

20. The system of claim 17, wherein said determining step comprises determining a success rate of a given subsequence from among the subsequences as a ratio between (i) a total number of successful subsequences that include the given subsequence and (ii) a total number of sequences that include the given subsequence.

21. The system of claim 17, further comprising a plurality of databases representing at least some of the different channels, and wherein the system is implemented using a distributed cloud configuration.

22. A method, comprising:
extracting subsequences from a sequence of a customer journey that includes customer interactions on different channels at different times;
measuring an effectiveness of each of the subsequences by applying a statistical hypothesis approach that computes a likelihood ratio test for each of the subsequences based on effective journey history; and
determining a contribution of each of the customer interactions for a given one of the subsequences by computing an attribution of the customer interactions using a sequence-based journey attribution model.

23. The method of claim 22, wherein the statistical hypothesis testing approach comprises computing a likelihood ratio test for each of the subsequences.

24. The method of claim 23, wherein computing the likelihood ratio test for a given subsequence from among the subsequences comprises determining successful journeys that include the given subsequence and unsuccessful journeys that include the given subsequence.

25. A non-transitory article of manufacture tangibly embodying a computer readable program which when executed causes a computer to perform the steps of claim 21.
